(19) United States
(12) Patent Application Publication
(10) Pub. No.: US 2026/0336888 A1
(43) Pub. Date: Oct. 29, 2026

(54) Tattoo Ink Bottle Cap with Integrated Mixing Mechanism

(71) Applicant: Fernando Omar Narvaez, Kennewick, WA (US)

(72) Inventor: Fernando Omar Narvaez, Kennewick, WA (US)

(21) Appl. No.: 19/189,287

(22) Filed: Apr. 25, 2025

(51) Int. Cl. B65D 51/32; B01F 27/211; B01F 27/88; B01F 27/90; B01F 35/30; B01F 35/32; B01F 35/45; B01F 101/35; B65D 47/12

(52) U.S. Cl. CPC B65D 51/32; B01F 27/211; B01F 27/88; B01F 27/90; B01F 35/3214; B01F 35/4521; B65D 47/123; B01F 2035/351; B01F 2101/35

(57) ABSTRACT

A container cap assembly with an integrated mixing mechanism configured to facilitate agitation and homogenization of fluids, pigments, inks, paints, or other liquid compositions within a container. The device includes a cap body adapted to engage a container opening, a central housing supporting a rotatable shaft, and a mixing element positioned within the container. Rotation of the shaft causes the mixing element to agitate the contents, reducing material separation and improving consistency prior to dispensing or use. The mechanism may be operated manually or by a motorized drive assembly coupled to an external power unit. The design enables controlled mixing without removing the cap, reducing contamination and improving efficiency in preparation and handling of liquid materials.

A threaded cap designed for tattoo ink bottles or pigment containers, featuring a built-in mixing mechanism operated via a rotating stainless steel rod. The cap includes a conical structure with a side spout for controlled pouring, and a central passage that houses a rotating rod connected to a hexagonal drive attachment. Seals and washers ensure a leak-free assembly. The system ensures uniform ink mixing before application.

### DETAILED DESCRIPTION

This invention relates to a cap (1) fabricated from injection-molded plastic or 3D-printed PETG filament, certified food-safe. The cap fits standard tattoo ink bottles and includes a built-in mechanism to mix the contents without opening the bottle.

The cap (1) has a threaded base and includes a pouring spout (2). At the center of the top section is a 6 mm diameter hole (3) into which a stainless steel tube (4) is inserted. The tube has a 6 mm outer diameter and a 3 mm inner diameter, with a solid stainless steel rod (5) inserted through it. The rod has a 3 mm diameter and is available in various lengths to suit different bottle sizes.

At the top of the rod (5), there is an octagonal coupling piece (6) secured by a socket screw (7), allowing external motor connection. Inside the cap, the rod is stabilized using a V-shaped silicone washer (8) and a stainless steel washer (9). A stopper ring (10) held in place with a 3 mm socket screw (11) ensures vertical alignment. At the bottom, a mixing fin (12) homogenizes the ink inside the bottle (13). A cap (14) seals the pouring spout when not in use.

### BRIEF DESCRIPTION OF THE DRAWINGS

FIG. 1 is an exploded view of the ink bottle cap assembly, illustrating the following components:
1. Cap for ink bottle
2. Pouring spout
5. Solid stainless steel rod (3 mm OD)
6. Octagonal top piece of the rod
7. Socket screw for securing the top piece
8. V-shaped silicone washer
9. Stainless steel washer
10. Stopper ring for locking
11. Socket screw (3 mm)
12. Mixing propeller (impeller)
13. Ink bottle
14. Cap for the pouring spout

FIG. 2 shows a lateral and a sectional view of the assembled device, demonstrating the internal alignment between the rod, tube, and impeller.

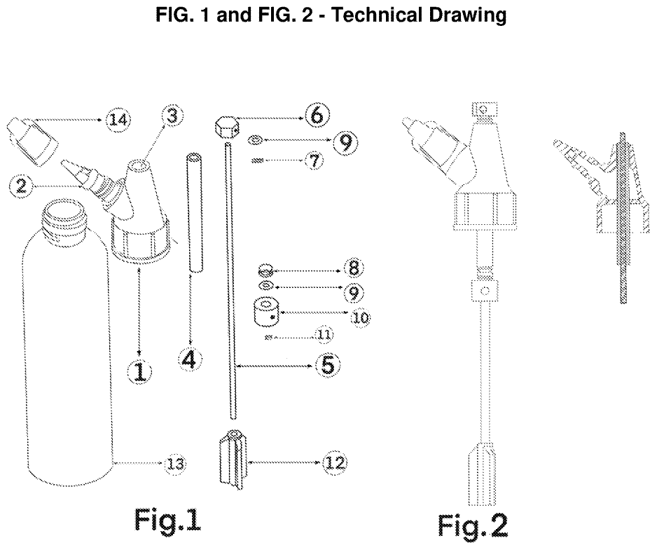

1. A bottle cap assembly for mixing fluid within a container, comprising:
a cap body formed of polymer material and configured to engage a neck of a container;
a tubular member extending centrally through the cap body;
a shaft rotatably disposed within the tubular member;
a mixing blade fixed to a lower end of the shaft and positioned within the container when the cap body is installed;
and a V-shaped sealing washer positioned between the shaft and the tubular member to prevent fluid leakage while permitting rotation of the shaft;
wherein rotation of the shaft causes mixing of fluid within the container.

2. The bottle cap assembly of claim 1, wherein the shaft is metallic.

3. The bottle cap assembly of claim 1, wherein the cap body includes internal threads configured to engage a threaded container neck.

4. The bottle cap assembly of claim 1, wherein an upper end of the shaft is configured to be engaged by an external rotational device.
